(19) United States
(12) Patent Application Publication
(10) Pub. No.: US 2023/0295017 A1
(43) Pub. Date: Sep. 21, 2023

(54) WATER RECOVERY SYSTEM AND WATER RECOVERY METHOD

(71) Applicant: ORGANO CORPORATION, Tokyo (JP)

(72) Inventor: Shohei YAMAMOTO, Tokyo (JP)

(73) Assignee: ORGANO CORPORATION, Tokyo (JP)

(21) Appl. No.: 17/912,694

(22) PCT Filed: Jan. 27, 2021
(86) PCT No.: PCT/JP2021/002718

§ 371 Date: Sep. 19, 2022

(30) Foreign Application Priority Data
Mar. 24, 2020 (JP) 2020-053020

(51) Int. Cl. C02F 1/44; C02F 1/50; C02F 1/76

(52) U.S. Cl. CPC C02F 1/441; C02F 1/505; C02F 1/766; C02F 2209/20; C02F 2209/29; C02F 2303/04; C02F 2303/185; C02F 2303/22; C02F 2305/02

(57) ABSTRACT

Provided is a water recovery system and a water recovery method whereby, in water recovery using a reverse osmosis membrane from water to be treated containing organic matter, it is possible to also suppress slime contamination on the secondary side of the reverse osmosis membrane. A water recovery system includes: a reverse osmosis membrane treatment device which separates water to be treated containing organic matter into permeated water and concentrated water with a reverse osmosis membrane; iodine-based oxidizing agent adding piping which adds an iodine-based oxidizing agent to the water to be treated; and permeated water piping as a supply means for supplying the permeated water as water to be treated in a water utilization system.

### TECHNICAL FIELD

The present invention relates to a water recovery system and a water recovery method that use a reverse osmosis membrane.

### BACKGROUND

The use of various antibacterial agents (slime inhibitors) as a method for suppressing biofouling (slime inhibition) in water treatment methods that use reverse osmosis membranes (RO membranes) is already well known. Chlorine-based oxidizing agents such as hypochlorous acid are typical antibacterial agents, and these oxidizing agents are usually added upstream from the reverse osmosis membrane for the purpose of slime inhibition, but because there is a high probability of causing degradation of the reverse osmosis membrane, methods in which the oxidizing agent is reduced immediately prior to the reverse osmosis membrane or methods that involve intermittent addition of the oxidizing agent are typically used.

Further, a method that involves introducing a combined chlorine agent formed from a chlorine-based oxidizing agent and a sulfamic acid compound as a slime inhibitor into a water to be treated by a reverse osmosis membrane (see Patent Document 1), and a method that involves adding a mixture or a reaction product of a sulfamic acid compound and either a bromine-based oxidizing agent or a reaction product of a bromine compound and a chlorine-based oxidizing agent (see Patent Document 2) are also known.

Antibacterial agents containing a chlorine-based oxidizing agent or a bromine-based oxidizing agent and a sulfamic acid compound exhibit superior sterilization capabilities, are also less likely to cause oxidative degradation of polyamide-based reverse osmosis membranes, have a high rejection rate by the reverse osmosis membrane, and have little effect on the quality of the downstream treated water (the permeate), and are therefore very effective.

However, because the vast majority of the antibacterial agent is rejected by the reverse osmosis membrane, even in those cases where the antibacterial agent is effective on the primary side of the reverse osmosis membrane, the permeate line on the secondary side may sometimes still suffer from slime contamination. Particularly in those cases where the water to be treated contains low-molecular weight organic matter (for example, with a molecular weight of 200 or lower), because the reverse osmosis membrane rejection rate for such low-molecular weight organic matter is low, even in those cases where the antibacterial agent is effective on the primary side of the reverse osmosis membrane, slime contamination caused by this low-molecular weight organic matter may sometimes occur on the secondary side.

On the other hand, Patent Document 3 discloses that by using an additive composed of iodine in a reverse osmosis membrane device, biological contamination of the reverse osmosis membrane device can be inhibited, and Patent Document 4 discloses a performance recovery treatment method for a semipermeable membrane that includes adding an iodine-containing solution containing added iodine and/or an iodine compound to a water to be treated, but both of these documents report only the effects on the reverse osmosis membrane and evaluations of the membrane performance, and no evaluations are reported of the effects of using iodine on the treated water (permeate) downstream from the reverse osmosis membrane.

### CITATION LIST

### Patent Literature

Patent Document 1: JP 2006-263510 A
Patent Document 2: JP 2015-062889 A
Patent Document 3: JP S56-033009 A
Patent Document 4: JP 2011-161435 A

### SUMMARY

### Technical Problem

An object of the present invention is to provide a water recovery system and a water recovery method which, in water recovery using a reverse osmosis membrane from a water to be treated containing organic matter, are capable of suppressing slime contamination even on the secondary side of the reverse osmosis membrane.

### Solution to Problem

The present invention provides a water recovery system that contains a reverse osmosis membrane treatment unit which separates a water to be treated containing organic matter into a permeate and a concentrate using a reverse osmosis membrane, an iodine-based oxidizing agent addition unit which adds an iodine-based oxidizing agent to the water to be treated, and a supply unit which supplies the permeate as a water to be treated in a water usage system.

In the above water recovery system, the water to be treated preferably contains organic matter with a molecular weight of 500 or lower.

In the above water recovery system, the organic matter concentration in the permeate, expressed as TOC, is preferably at least 0.01 mg/L.

In the above water recovery system, the total chlorine concentration in the permeate is preferably at least 0.01 mg/L.

In the above water recovery system, it is preferable that the reverse osmosis membrane is a polyamide-based reverse osmosis membrane, and that the chlorine content of the membrane surface of the reverse osmosis membrane is at least 0.1 atom%.

In the above water recovery system, it is preferable either that an iodine removal unit which removes iodine components from within the permeate is also included, or that the water usage system contains an iodine removal unit which removes iodine components from within the permeate.

The present invention also provides an iodine-based slime inhibitor which can be used in the above water recovery system.

It is preferable that the iodine-based slime inhibitor contains water, iodine and an iodide, and has an organic matter content of less than 100 mg/L.

The present invention also provides a water recovery method that includes a reverse osmosis membrane treatment step of separating a water to be treated containing organic matter into a permeate and a concentrate using a reverse osmosis membrane, an iodine-based oxidizing agent addition step of adding an iodine-based oxidizing agent to the water to be treated, and a supply step of supplying the permeate as a water to be treated in a water usage system.

In the above water recovery method, the water to be treated is preferably a biologically treated water obtained from a biological treatment unit.

The above water recovery method preferably also includes a second stage reverse osmosis membrane treatment step of subjecting the permeate from the reverse osmosis membrane treatment step to an additional reverse osmosis membrane treatment.

In the above water recovery method, the organic matter concentration in the permeate, expressed as TOC, is preferably at least 0.01 mg/L.

In the above water recovery method, the total chlorine concentration in the permeate is preferably at least 0.01 mg/L.

In the above water recovery method, it is preferable that the reverse osmosis membrane is a polyamide-based reverse osmosis membrane, and that the chlorine content of the membrane surface of the reverse osmosis membrane is at least 0.1 atom%.

In the above water recovery method, it is preferable either that an iodine removal step of removing iodine components from within the permeate is also included, or that the water usage system includes an iodine removal step of removing iodine components from within the permeate.

### Advantageous Effects of Invention

The present invention is able to provide a water recovery system and a water recovery method which, in water recovery using a reverse osmosis membrane from a water to be treated containing organic matter, are capable of suppressing slime contamination even on the secondary side of the reverse osmosis membrane.

### BRIEF DESCRIPTION OF DRAWINGS

FIG. 1 is a schematic structural diagram illustrating one example of a water recovery system according to an embodiment of the present invention.

FIG. 2 is a schematic structural diagram illustrating another example of a water recovery system according to an embodiment of the present invention.

FIG. 3 is a schematic structural diagram illustrating yet another example of a water recovery system according to an embodiment of the present invention.

FIG. 4 is a schematic structural diagram illustrating yet another example of a water recovery system according to an embodiment of the present invention.

FIG. 5 is a schematic structural diagram illustrating yet another example of a water recovery system according to an embodiment of the present invention.

FIG. 6 is a schematic structural diagram illustrating yet another example of a water recovery system according to an embodiment of the present invention.

FIG. 7 is a graph illustrating total chlorine permeation rate (%) in Examples 3 to 6.

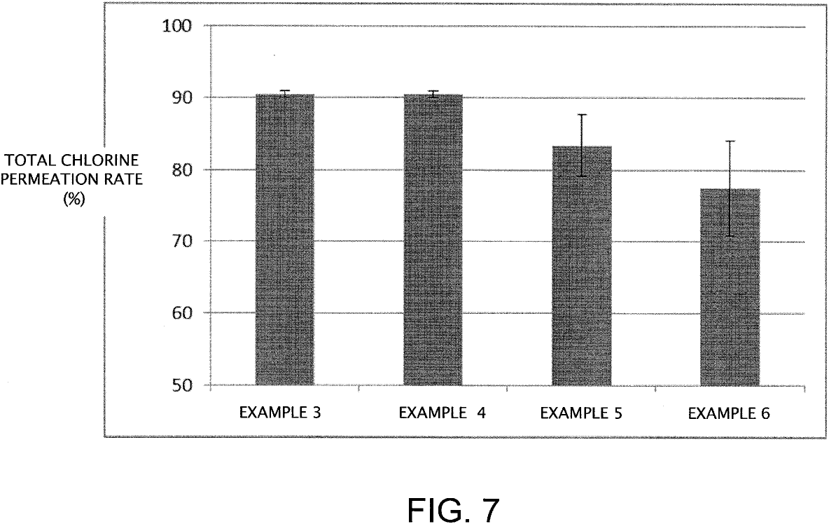

FIG. 8 is a graph illustrating the permeate concentration (µg/L) in Example 7 (total iodine CT value: 20 (mg/L·min)).

FIG. 9 is a graph illustrating the permeate concentration (µg/L) in Example 7 (total iodine CT value: 50 (mg/L·min)).

FIG. 10 is a graph illustrating the change over time in a value obtained by subtracting the initial water flow differential pressure (kPa) from the actually measured water flow differential pressure (kPa) in Example 9.

FIG. 11 is a graph illustrating the bacterial count (CFU/mL) relative to the time elapsed (min) in Example 10.

FIG. 12 is a graph illustrating the total chlorine concentration (mg/L) relative to the time elapsed in Example 13.

### DESCRIPTION OF EMBODIMENTS

Embodiments of the present invention are described below. These embodiments are merely examples of implementing the present invention, and the present invention is not limited to these embodiments.

### Water Recovery System and Water Recovery Method Using Reverse Osmosis Membrane

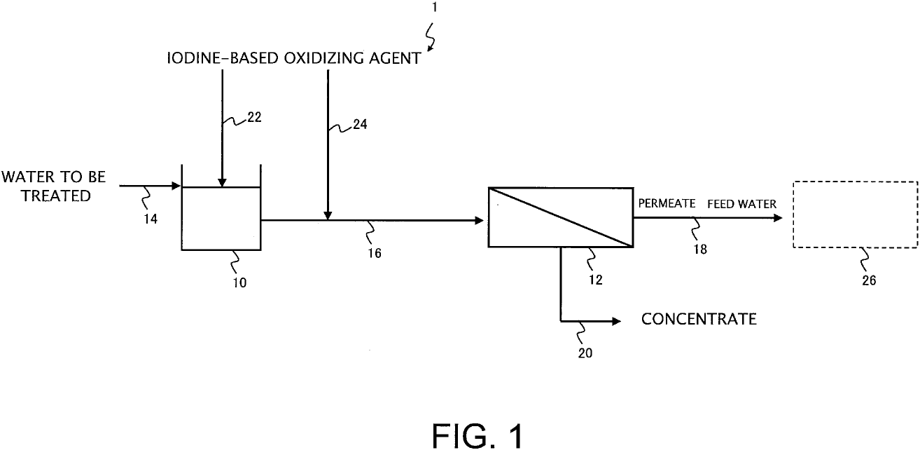

An outline of one example of a water recovery system according to an embodiment of the present invention is illustrated in FIG. 1, and the structure of that system is described below.

The water recovery system 1 illustrated in FIG. 1 contains a reverse osmosis membrane treatment device 12 as a reverse osmosis membrane treatment unit which separates a water to be treated containing organic matter into a permeate and a concentrate using a reverse osmosis membrane. The water recovery system 1 may also contain a water to be treated tank 10 for storing the water to be treated.

In the water recovery system 1, a water to be treated line 14 is connected to an inlet of the water to be treated tank 10. The outlet of the water to be treated tank 10 and the inlet on the primary side of the reverse osmosis membrane treatment device 12 are connected by a water to be treated supply line 16. A permeate line 18 is connected to the permeate outlet on the secondary side of the reverse osmosis membrane treatment device 12, while a concentrate line 20 is connected to the concentrate outlet on the primary side, and the permeate line 18 is connected to a water usage system 26 outside the water recovery system. An iodine-based oxidizing agent addition line 22 or an iodine-based oxidizing agent addition line 24 is connected to at least one of the water to be treated tank 10 and the water to be treated supply line 16 as an iodine-based oxidizing agent addition unit for adding an iodine-based oxidizing agent to the water to be treated.

In the water recovery system 1, the water to be treated is passed through the water to be treated line 14 and, if necessary, is fed into the water to be treated tank 10 and stored. In the water to be treated tank 10, an iodine-based oxidizing agent is passed through the iodine-based oxidizing agent addition line 22 and added to the water to be treated, thereby introducing an iodine-based oxidizing agent (an iodine-based oxidizing agent addition step). The iodine-based oxidizing agent may also be added to the water to be treated line 14, or as illustrated in FIG. 1, may be passed through the iodine-based oxidizing agent addition line 24 and added to the water to be treated supply line 16.

The water to be treated containing the added iodine-based oxidizing agent is passed through the water to be treated supply line 16 and supplied to the reverse osmosis membrane treatment device 12, and is separated into a permeate and a concentrate by the reverse osmosis membrane in the reverse osmosis membrane treatment device 12 (a reverse osmosis membrane treatment step). The permeate obtained in the reverse osmosis membrane treatment is passed through the permeate line 18 as a treated water, and is supplied to the water usage system 26 as a water to be treated (a supply step), whereas the concentrate is passed through the concentrate line 20 and discharged. Here, the permeate line 18 functions as the supply unit for supplying the permeate to the water usage system as a water to be treated.

As a result of intensive investigation, the inventors of the present invention discovered that by using an iodine-based oxidizing agent as the antibacterial agent, a satisfactory concentration of iodine was able to permeate through the reverse osmosis membrane, which is considered to provide the best removal performance for ions and salts. Accordingly, in a water recovery process from a water to be treated containing organic matter using a reverse osmosis membrane, slime contamination is able to be suppressed even on the secondary side of the reverse osmosis membrane.

In particular, polyamide-based polymer membranes such as polyamide-based reverse osmosis membranes, which are currently the most widely used type of reverse osmosis membrane, have comparatively low resistance to oxidizing agents, and if free chlorine or the like is kept in continuous contact with a polyamide-based reverse osmosis membrane or the like, then a marked deterioration in membrane performance tends to occur. However, in a water recovery method in which an iodine-based oxidizing agent is added to the water to be treated, this type of marked deterioration in membrane performance is less likely, even for polyamide-based reverse osmosis membranes and the like.

The iodine-based oxidizing agent is an oxidizing agent that contains iodine. The “iodine” contained in the iodine-based oxidizing agent may be of any form, and may be one, or a combination, of molecular iodine, an iodide, a polyiodide, iodic acid, hypoiodous acid, hydrogen iodide, or iodine that is coordinated to an organic solvent such as polyvinylpyrrolidone or cyclodextrin. Further, the method used for obtaining any of these forms of iodine may employ a method in which solid iodine is dissolved in a non-polar solvent such as benzene or carbon tetrachloride or an alcohol, dissolved using an alkali agent and water, or dissolved using an iodide salt and water, or may yield total iodine by adding an acid or an oxidizing agent to a solvent containing at least one of an iodide salt and iodide ions. Furthermore, iodine that is coordinated to an organic solvent such as polyvinylpyrrolidone or cyclodextrin may be obtained using povidone-iodine which is composed of iodine coordinated to polyvinylpyrrolidone, cyclodextrin-iodine inclusion complex which is composed of an inclusion of iodine in cyclodextrin, or iodophors composed of iodine supported on an organic polymer or surfactant or the like. From the viewpoints of handling properties and water quality effects on the water to be treated and the treated water, the iodine-based oxidizing agent is preferably obtained by dissolving solid iodine using an iodide salt and water, without using any organic substances. The term “iodide” refers to iodine compounds with an oxidation number of 1, and examples include potassium iodide, sodium iodide, hydrogen iodide and silver iodide. Further, these iodides, of course, dissociate upon dissolution in water to form iodide ions. Examples of the iodide salt include inorganic iodide salts such as sodium iodide and potassium iodide, and the use of potassium iodide is preferred.

The water recovery system and water recovery method according to embodiments of the present invention can be applied particularly favorably in those cases where the water to be treated contains an amount of organic matter, and particularly organic matter that can readily permeate the reverse osmosis membrane, expressed as TOC, that is at least 0.01 mg/L, preferably at least 0.1 mg/L, and more preferably at least 0.5 mg/L but not more than 500 mg/L. If the organic matter content of the water to be treated is less than 0.01 mg/L, then slime contamination on the secondary side of the reverse osmosis membrane is unlikely to occur, and therefore the slime inhibitory effect provided by the iodine-based oxidizing agent may sometimes not manifest adequately.

Further, the water recovery system and water recovery method according to embodiments of the present invention can be applied particularly favorably in those cases where the organic matter concentration in the permeate, expressed as TOC, is at least 0.01 mg/L, preferably at least 0.05 mg/L, and more preferably at least 0.1 mg/L but not more than 100 mg/L. If the organic matter concentration in the permeate, expressed as TOC, is less than 0.01 mg/L, then slime contamination on the secondary side of the reverse osmosis membrane is unlikely to occur, and therefore the slime inhibitory effect provided by the iodine-based oxidizing agent may sometimes not manifest adequately.

The amount of iodine-based oxidizing agent contacting the reverse osmosis membrane, expressed as a total chlorine concentration, is preferably at least 0.01 mg/L, more preferably within a range from 0.01 to 100 mg/L (equivalent to a total iodine concentration of 0.035 to 350 mg/L), and even more preferably within a range from 0.05 to 10 mg/L. If the amount of iodine contacting the reverse osmosis membrane, expressed as a total chlorine concentration, is less than 0.01 mg/L, then a satisfactory slime inhibitory effect may sometimes be unattainable, whereas an amount of iodine exceeding 100 mg/L may sometimes cause degradation of the reverse osmosis membrane or corrosion of the lines and the like. In such cases, the total chlorine concentration in the permeate is typically at least 0.01 mg/L, and preferably within a range from 0.01 to 100 mg/L.

In this description, the oxidizing power of all the oxidizing agents is represented by the total chlorine value determined using the DPD method. In this description, the term “total chlorine” refers to a value determined by absorption spectrophotometry using N,N-diethyl-p-phenylenediammonium sulfate (DPD) as disclosed in section 33 “Residual Chlorine” in JIS K 0120:2013. In one example, 2.5 mL of a 0.2 mol/L potassium dihydrogen phosphate solution is placed in a 50 mL colorimetric tube, 0.5 g of a dilute powder of DPD (prepared by crushing 1.0 g of N,N-diethyl-p-phenylenediammonium sulfate and then mixing the powder with 24 g of sodium sulfate) is added, 0.5 g of potassium iodide is added, an appropriate amount of the sample is added, water is then added to bring the volume up to the marked line and dissolve the mixture, and the resulting solution is left to stand for about three minutes. The absorbance of the resulting pink to pinky red color is measured near a wavelength of 510 nm (or 555 nm) and used to quantify the oxidizing agents. DPD is oxidized by all manner of oxidizing agents, and examples of oxidizing agents that can be measured include chlorine, bromine, iodine, hydrogen peroxide, and ozone and the like. In the case of the iodine-based oxidizing agent used in embodiments of the present invention, all the iodine forms that have oxidizing power (for example, I₂, IO₃⁻, IO⁻, HI) can be jointly measured as “total chlorine”. Further, “total chlorine” may be converted to “total iodine”. Specifically, a conversion may be made based on the “molecular weight of chlorine” and the “molecular weight of iodine”. In other words, “total chlorine” × (126.9/35.45) ≈ “total chlorine” × 3.58 = “total iodine”.

In the iodine-based oxidizing agent addition step, the total iodine CT value (mg/L·h) represented by (total iodine within the water to be treated (mg/L)) × (iodine-based oxidizing agent addition time (h)) is preferably at least 0.7 (mg/L·h), and more preferably 1.0 (mg/L·h) or higher. Provided the total iodine CT value (mg/L·h) is at least 0.7 (mg/L·h), permeation of the iodine-based oxidizing agent through the reverse osmosis membrane can be increased, meaning any slime contamination on the secondary side of the reverse osmosis membrane can be better suppressed.

In those cases where the iodine-based oxidizing agent is an oxidizing agent obtained by dissolving iodine using an iodide salt such as potassium iodide, namely an oxidizing agent that contains iodine and iodide, the molar ratio of iodide (at least one of an iodide salt and iodide ions) relative to iodine (namely, iodide (at least one of an iodide salt and iodide ions) / iodine) is preferably at least 1 but not more than 3, and more preferably at least 1.5 but not more than 2.5. If the molar ratio of iodide relative to iodine (namely, iodide (at least one of an iodide salt and iodide ions) / iodine) is lower than 1, then the concentration of iodine that permeates through the reverse osmosis membrane may sometimes decrease.

The method used for adding the iodine-based oxidizing agent to the water to be treated may involve continuous addition in which the iodine-based oxidizing agent is added continuously, or intermittent addition which provides an addition period during which the iodine-based oxidizing agent is added to the water to be treated and a non-addition period during which the iodine-based oxidizing agent is not added to the water to be treated. Compared with other oxidizing agents such as chlorine-based oxidizing agents and bromine-based oxidizing agents, iodine-based oxidizing agents are comparatively expensive, but exhibit stronger sterilizing power, and in those cases where continuous addition results in increased costs associated with slime inhibition, a satisfactory slime inhibitory effect can be achieved even with intermittent addition. Further, iodine is fast acting, meaning the addition period can be set to a short time period. If the iodine-based oxidizing agent is added continuously to the water to be treated, then the active component can be incorporated within the water to be treated at all times.

In the water recovery system and water recovery method according to embodiments of the present invention, by adding an iodine-based oxidizing agent to the water to be treated, for example in a continuous manner, the iodine adsorbs to the reverse osmosis membrane, and even if the addition of the iodine-based oxidizing agent is stopped, the active component is released gradually from the reverse osmosis membrane. As a result, even in those cases where troubles or faults result in the stoppage of the water recovery system or the iodine-based oxidizing agent injection pump or the like, causing the water to reside within the system for a long period of time, or cases where the addition of the iodine-based oxidizing agent is stopped, a continuous sterilization effect can still be obtained. Furthermore, as a result of adsorption of the active component to the reverse osmosis membrane, not only can sterilization and cleaning be achieved from the biofilm outer surface (on the side of the flow path), as is the case with conventional antibacterial agents, but sterilization and cleaning effects can also be expected from the rear surface of the biofilm (the adhesive surface between the biofilm and the membrane).

Furthermore, because iodine exhibits a high level of permeability, not only can the type of inhibitory effect on slime formation described above be achieved, but the iodine can penetrate into the interior of previously formed slime, providing an effective slime detachment effect.

The pH of the water to be treated is preferably within a range from 2 to 12, and more preferably within a range from 4 to 9. If the pH of the water to be treated exceeds 9, then the slime inhibitory effect tends to deteriorate due to a reduction in the amount of the active component, and if the pH exceeds 12, then a satisfactory slime inhibitory effect may sometimes be unattainable, whereas if the pH is less than 2, then crystals of iodine may sometimes precipitate, and a satisfactory slime inhibitory effect may sometimes be unattainable.

Examples of organic matter that can readily permeate through reverse osmosis membranes include low-molecular weight organic substances. Low-molecular weight organic substances are organic substances with a molecular weight of 500 or lower, and examples include alcohol compounds such as methanol, ethanol and isopropyl alcohol, amine compounds such as monoethanolamine and urea, tetraalkylammonium salts such as tetramethylammonium hydroxide, and carboxylic acids such as acetic acid.

It is known that the removal rate by a reverse osmosis membrane decreases as the molecular weight decreases. It is widely known that the low-molecular weight organic substances described above have low removal rates even by reverse osmosis membranes, and for example, it is known that the types of low-molecular weight organic substances shown in Table 1 and Table 2 permeate through reverse osmosis membranes, and that organic substances with a molecular weight of 500 or lower exhibit a particularly high reverse osmosis membrane permeation rate. Further, it is generally accepted that organic substances having one or fewer side chains have higher reverse osmosis membrane permeation rates.

TABLE 1

Reverse osmosis membrane permeation rates for alcohols

| Name of substance | Molecular weight | Permeation rate (%) | Number of side chains |
|---|---|---|---|
| Methanol | 32 | 95 | - |
| Ethanol | 46 | 80 | - |
| Isopropyl alcohol | 60 | 20 | 1 |
| Ethylene glycol | 62 | 55 | - |
| Diethylene glycol | 106 | 15 | - |
| Triethylene glycol | 150 | 5 | - |
| Polyethylene glycol | 200 | 3 | - |
| | 300 | 0.8 | - |
| Propylene glycol | 76 | 8.8 | 1 |
| Dipropylene glycol | 134 | 0.9 | 2 |
| Tripropylene glycol | 192 | 0.3 | 3 |

TABLE 2

Reverse osmosis membrane permeation rates for other low-molecular weight substances

| Name of substance | Molecular weight | Permeation rate (%) |
|---|---|---|
| Urea | 60 | 50 |
| Ethylenediamine | 60 | 10 |
| Tetramethylammonium hydroxide | 91 | 10 |
| Oxalic acid | 90 | 10 |
| Acetic acid | 60 | 30 |
| Acetone | 58 | 60 |

There are no particular limitations on the type of membrane used or the operating pressure in the water recovery system and water recovery method according to embodiments of the present invention, and operation may be conducted at any pressure that yields a permeate from the reverse osmosis membrane. For example, a salt water reverse osmosis membrane (low pressure reverse osmosis membrane) may be operated at 0.2 to 1.2 MPa, a seawater desalination reverse osmosis membrane (high pressure reverse osmosis membrane) may be operated at 3 to 5.5 MPa, and a seawater desalination reverse osmosis membrane (high pressure reverse osmosis membrane) may be operated for a salt water application at a pressure of 1.5 to 3.5 MPa.

In those cases where the reverse osmosis membrane is a polyamide-based reverse osmosis membrane, the chlorine content of the membrane surface of the reverse osmosis membrane is preferably at least 0.1 atom%, and is more preferably 0.5 atom% or greater. If the chlorine content of the membrane surface of the reverse osmosis membrane is less than 0.1 atom%, then the amount of iodine permeation may sometimes decrease, and the inhibitory effect on slime contamination on the secondary side of the reverse osmosis membrane may weaken. The chlorine content of the reverse osmosis membrane surface can be measured by X-ray photoelectron spectroscopy.

The treated water (permeate) obtained from the water recovery system and water recovery method according to embodiments of the present invention is supplied (recovered) as a water to be treated in the water usage system 26, but there are no particular limitations on the water usage system 26, which may be any type of water usage facility, and for example, the permeate may be supplied to and used in a separation membrane treatment device, an ion removal device, a pure water production device, a cooling tower, as scrubber water, or supplied to the water storage tank of a facility. In those cases where the water usage system 26 is a separation membrane treatment device, an ion removal device or a pure water production device, because low-molecular weight organic matter contained in the treated water (permeate) is a slime formation risk, the water recovery system and water recovery method of embodiments of the present invention can be used particularly favorably. In those cases where the water usage system 26 is a cooling tower, scrubber water, or the storage tank for water used in a facility, low-molecular weight organic matter contained in the treated water (permeate), and the fact that the water exists in a gas-liquid mixed state increase the risk of slime formation, and therefore the water recovery system and water recovery method of embodiments of the present invention can be used particularly favorably.

The water to be treated by the reverse osmosis membrane treatment device 12 in the water recovery system and water recovery method according to embodiments of the present invention is a water to be treated that contains organic matter, and may be a water to be treated that contains organic matter and nitrogen compounds. An example of a water to be treated containing organic matter is the treated water obtained from a wastewater treatment unit. The wastewater treatment unit may use any of biological treatment, coagulation and settling, pressure flotation, sand filtration or biological activated carbon, or may use a combination of these techniques. The water to be treated may also include a biologically treated water obtained from a biological treatment unit (a biological treatment step).

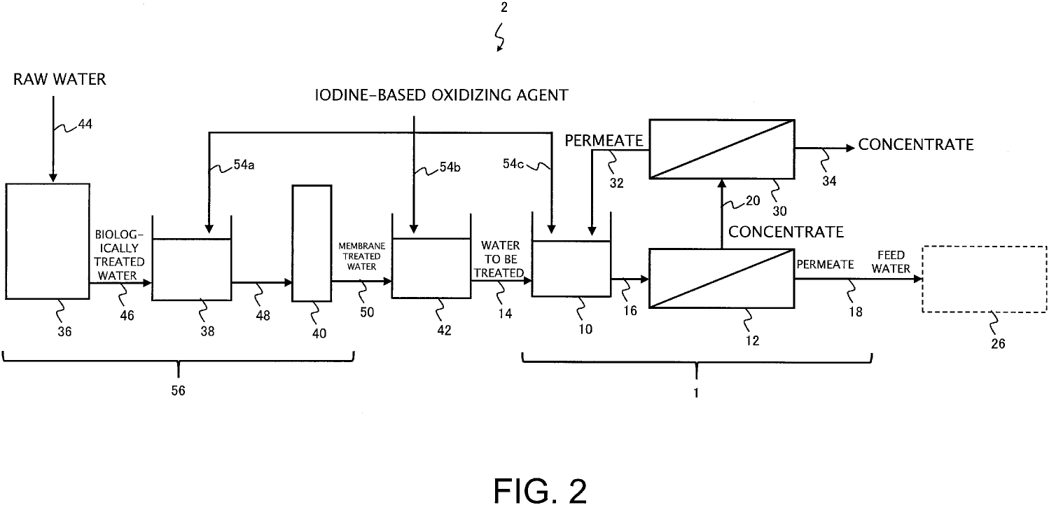

It is thought that the water recovery system and water recovery method according to embodiments of the present invention will be particularly suited to application to wastewater recovery, such as the recovery of wastewater from the electronics industry, food production wastewater, beverage production wastewater, chemical plant wastewater, and plating plant wastewater and the like. In particular, water recovered from wastewater from the electronics industry often contains ammonia, and one example of a possible wastewater recovery flow in such a case is the type of flow illustrated in FIG. 2, having the water recovery system 1, which contains the reverse osmosis membrane treatment device 12 and utilizes the water recovery system and water recovery method according to embodiments of the present invention, located downstream from a biological treatment system 56 containing a biological treatment device 36 and a membrane treatment device 40.

The water treatment system 2 illustrated in FIG. 2 contains, for example, the biological treatment device 36 as a biological treatment unit, a biologically treated water tank 38, the membrane treatment device 40 as a membrane treatment unit, a membrane treated water tank 42, and the water recovery system 1. The water treatment system 2 may also contain a second reverse osmosis membrane treatment device 30 as a second reverse osmosis membrane treatment unit.

In the water treatment system 2, a raw water line 44 is connected to the inlet of the biological treatment device 36. The outlet of the biological treatment device 36 and the inlet of the biologically treated water tank 38 are connected by a biologically treated water line 46. The outlet of the biologically treated water tank 38 and the inlet of the membrane treatment device 40 are connected by a biologically treated water supply line 48. The outlet of the membrane treatment device 40 and the inlet of the membrane treated water tank 42 are connected by a membrane treated water line 50. The outlet of the membrane treated water tank 42 and the inlet of the water to be treated tank 10 are connected by the water to be treated line 14. The outlet of the water to be treated tank 10 and the inlet on the primary side of the reverse osmosis membrane treatment device 12 are connected by the water to be treated supply line 16. The permeate line 18 is connected to the permeate outlet on the secondary side of the reverse osmosis membrane treatment device 12, and the permeate line 18 is connected to the water usage system 26 that is outside the system. The concentrate outlet on the primary side of the reverse osmosis membrane treatment device 12 and an inlet on the primary side of the second reverse osmosis membrane treatment device 30 are connected by the concentrate line 20. A concentrate line 34 is connected to a concentrate outlet on the primary side of the second reverse osmosis membrane treatment device 30, and a permeate outlet on the secondary side of the second reverse osmosis membrane treatment device 30 and a permeate inlet of the water to be treated tank 10 are connected by a permeate line 32. At least one iodine-based oxidizing agent addition line 54a, 54b or 54c is connected to at least one of the biologically treated water tank 38, the membrane treated water tank 42 and the water to be treated tank 10 as an iodine-based oxidizing agent addition unit for adding an iodine-based oxidizing agent to the water to be treated.

In the water treatment system 2, a raw water such as a wastewater from the electronics industry is passed through the raw water line 44 and fed into the biological treatment device 36, and a biological treatment is conducted in the biological treatment device 36 (a biological treatment step). The biologically treated water that has undergone this biological treatment is stored in the biologically treated water tank 38 if necessary, is subsequently fed into the membrane treatment device 40, and is then subjected to a membrane treatment (turbidity removal) by a turbidity removal membrane or the like in the membrane treatment device 40 (a membrane treatment step). The membrane treated water that has undergone this membrane treatment is stored in the membrane treated water tank 42 if necessary, subsequently passed through the water to be treated line 14 as a water to be treated, and fed into the water to be treated tank 10 of the water recovery system 1 and stored if necessary. Subsequently, for example, an iodine-based oxidizing agent is passed through the iodine-based oxidizing agent addition line 54c and added to the water to be treated in the water to be treated tank 10, thereby introducing an iodine-based oxidizing agent (an iodine-based oxidizing agent addition step). The iodine-based oxidizing agent may also be added to the biologically treated water tank 38 through the iodine-based oxidizing agent addition line 54a, added to the membrane treated water tank 42 through the iodine-based oxidizing agent addition line 54b, added to the water to be treated line 14, or added to the water to be treated supply line 16.

The water to be treated containing the added iodine-based oxidizing agent is fed through the water to be treated supply line 16 and supplied to the reverse osmosis membrane treatment device 12, and is separated into a permeate and a concentrate by the reverse osmosis membrane in the reverse osmosis membrane treatment device 12 (a reverse osmosis membrane treatment step). The permeate obtained in the reverse osmosis membrane treatment is passed through the permeate line 18 as a treated water and supplied to the water usage system 26 as a water to be treated (a supply step), whereas the concentrate is passed through the concentrate line 20 and discharged. If necessary, the concentrate obtained in the reverse osmosis membrane treatment may be fed into the second reverse osmosis membrane treatment device 30, and an additional reverse osmosis membrane treatment may be conducted in the second reverse osmosis membrane treatment device 30 (a second reverse osmosis membrane treatment). The concentrate obtained in the second reverse osmosis membrane treatment is passed through the concentrate line 34 and discharged outside the system. The permeate obtained in the second reverse osmosis membrane treatment may be discharged outside the system, or if necessary, may be passed through the permeate line 32 and recirculated into the water to be treated tank 10.

In the water treatment system 2 of FIG. 2, the biological treatment system 56 having a separate biological treatment device 36, biologically treated water tank 38, and membrane treatment device 40 is shown as an example, but a membrane separation activated sludge device (MBR) which combines these devices into a single unit may also be used.

In the water treatment system 2 of FIG. 2, the raw water contains organic matter such a low-molecular weight organic matter, and this organic matter is not adequately removed in the biological treatment system 56, and still remains in the treated water from the biological treatment system 56, and therefore introduction of this treated water into the water to be treated by the water recovery system 1 can sometimes lead to contamination of the permeate line 18 and the like of the reverse osmosis membrane treatment device 12.

When nitrogen removal is conducted using a biological treatment method such as an activated sludge method, an inexpensive low-molecular weight organic substance such as methanol is often added as a hydrogen donor in the denitrification step. The inexpensive low-molecular weight organic substance such as methanol added at this time is usually decomposed in a downstream re-aeration tank, but there is a possibility that some of the organic substance may remain, and be retained in the treated water from the biological treatment system 56. As a result, this organic substance is incorporated within the water to be treated by the reverse osmosis membrane treatment device 12, and can lead to contamination of the permeate line 18 or the like of the reverse osmosis membrane treatment device 12. In some methods, a raw water containing organic matter may be added as a hydrogen donor, but in other cases the raw water may contain low-molecular weight organic matter, and in a similar manner to those cases where a low-molecular weight substance such as methanol is added, there is possibility that the organic matter may remain in the treated water from the biological treatment system 56.

As outlined above, it is known that the removal rate for methanol by reverse osmosis membranes is extremely low, and the removal rate for other low-molecular weight organic substances is also low, and therefore when the treated water obtained from a wastewater treatment unit such as a biological treatment system is used as the water to be treated by a reverse osmosis membrane treatment unit, there is a high risk that the water to be treated will be contaminated with low-molecular weight organic matter, leading to contamination of the permeate line and the like from the reverse osmosis membrane. In the water treatment system 2 of FIG. 2, by introducing a satisfactory concentration of a permeable iodine-based oxidizing agent into the water to be treated by the reverse osmosis membrane, contamination of the permeate line and the like of the reverse osmosis membrane can be suppressed.

In a wastewater recovery flow such as the water treatment system 2, the second reverse osmosis membrane treatment device 30 (brine RO) is typically provided to increase the water recovery rate. The second reverse osmosis membrane treatment device 30 utilizes the concentrate from the reverse osmosis membrane treatment device 12 as the water to be treated, and then, for example, returns the resulting permeate to the water to be treated tank 10 and discharges the concentrate outside the system.

In the water treatment system 2 of FIG. 2, a biological treatment was described as an example of a pretreatment to the reverse osmosis membrane treatment, but this pretreatment step prior to the reverse osmosis membrane treatment may, if necessary, involve conducting a biological, physical or chemical pretreatment such as a biological treatment, coagulation treatment, coagulation and settling treatment, pressure flotation treatment, filtration treatment, membrane separation treatment, activated carbon treatment, ozone treatment or ultraviolet irradiation treatment, or a combination of two or more of these pretreatments.

In the water treatment system 2, in addition to the reverse osmosis membrane, if necessary, the system may also contain a pump, safety filter, flow rate measurement device, pressure measurement device, temperature measurement device, oxidation-reduction potential (ORP) measurement device, residual chlorine measurement device, electrical conductivity measurement device, pH measurement device, and/or energy recovery device or the like.

In the water treatment system 2, if necessary, a scale inhibitor other than the iodine-based oxidizing agent or a pH modifier may be added to at least one of the biologically treated water, the membrane treated water, or the water to be treated in at least one of the biologically treated water tank 38 or the lines upstream and downstream thereof, the membrane treated water tank 42 or the lines upstream and downstream thereof, and the water to be treated tank 10 or the lines upstream and downstream thereof.

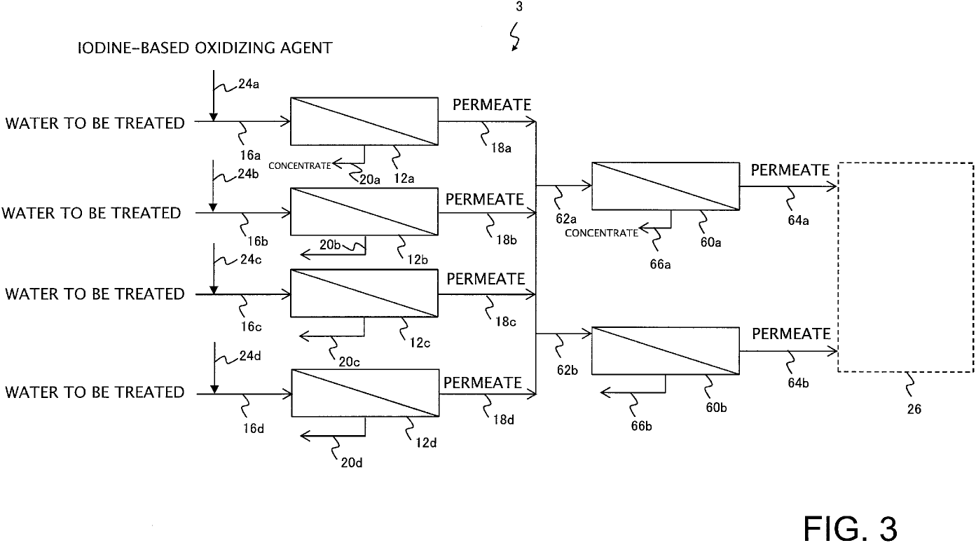

The water recovery system and water recovery method according to embodiments of the present invention may also include a second stage reverse osmosis membrane treatment unit for conducting an additional reverse osmosis membrane treatment of the permeate from the reverse osmosis membrane treatment device 12 that functions as the reverse osmosis membrane treatment unit. For example, a flow such as that illustrated in FIG. 3 may be conceived, in which at least one second stage reverse osmosis membrane treatment device 60 (in the example in FIG. 3, two second stage reverse osmosis membrane treatment devices 60a and 60b) which functions as a second stage reverse osmosis membrane treatment unit that subjects the permeate from the reverse osmosis membrane treatment device 12 to an additional reverse osmosis membrane treatment may be provided downstream from the one or more reverse osmosis membrane treatment devices 12 (in the example in FIG. 3, four reverse osmosis membrane treatment devices 12a, 12b, 12c and 12d) that apply the water recovery system and water recovery method using a reverse osmosis membrane according to embodiments of the present invention.

In the water recovery system 3 illustrated in FIG. 3, water to be treated supply lines 16a, 16b, 16c and 16d are connected to the inlets on the primary side of the reverse osmosis membrane treatment devices 12a, 12b, 12c and 12d respectively. Permeate lines 18a, 18b, 18c and 18d are connected to the permeate outlets on the secondary side of the reverse osmosis membrane treatment devices 12a, 12b, 12c and 12d respectively, whereas concentrate lines 20a, 20b, 20c and 20d are connected to the concentrate outlets on the primary side. The permeate lines 18a, 18b, 18c and 18d merge into permeate lines 62a and 62b, with the permeate line 62a connected to the inlet on the primary side of the second reverse osmosis membrane treatment device 60a and the permeate line 62b connected to the inlet on the primary side of the second reverse osmosis membrane treatment device 60b. A permeate line 64a is connected to the permeate outlet on the secondary side of the second reverse osmosis membrane treatment device 60a, and a concentrate line 66a is connected to the concentrate outlet on the primary side, with the permeate line 64a connected to the water usage system 26 outside the system. A permeate line 64b is connected to the permeate outlet on the secondary side of the second reverse osmosis membrane treatment device 60b, and a concentrate line 66b is connected to the concentrate outlet on the primary side, with the permeate line 64b connected to the water usage system 26 outside the system. The permeate line 64a and the permeate line 64b may also be connected to separate water usage systems outside the system.

Iodine-based oxidizing agent addition lines 24a, 24b, 24c and 24d are connected to the water to be treated supply lines 16a, 16b, 16c and 16d respectively as iodine-based oxidizing agent addition units for adding an iodine-based oxidizing agent to the water to be treated.

In the water recovery system 3, the water to be treated is passed through the respective water to be treated lines, fed into a water to be treated tank and stored if necessary, and an iodine-based oxidizing agent is then added through the iodine-based oxidizing agent addition lines 24a, 24b, 24c and 24d to the water to be treated in the water to be treated supply lines 16a, 16b, 16c and 16d respectively, thus introducing an iodine-based oxidizing agent into the water to be treated (an iodine-based oxidizing agent addition step). The iodine-based oxidizing agent may also be added to a water to be treated tank that is connected to each of the water to be treated supply lines 16a, 16b, 16c and 16d, or may be added to a water to be treated line connected to the water to be treated tank.

The water to be treated containing the added iodine-based oxidizing agent is passed through the water to be treated supply lines 16a, 16b, 16c and 16d and supplied to the reverse osmosis membrane treatment devices 12a, 12b, 12c and 12d respectively, and is separated into a permeate and a concentrate by the reverse osmosis membrane in each of the reverse osmosis membrane treatment devices 12a, 12b, 12c and 12d (a reverse osmosis membrane treatment step). The permeates obtained in the reverse osmosis membrane treatments are passed through the permeate lines 18a, 18b, 18c and 18d as a treated water, and is supplied to the second reverse osmosis membrane treatment devices 60a and 60b through the permeate lines 62a and 62b respectively. The concentrates are passed through the concentrate lines 20a, 20b, 20c and 20d respectively and discharged. In each of the second reverse osmosis membrane treatment devices 60a and 60b, a further separation into a permeate and a concentrate is conducted using the reverse osmosis membrane (a second reverse osmosis membrane treatment step). The permeates obtained in the second reverse osmosis membrane treatment are passed through the permeate lines 64a and 64b as a treated water, and are supplied as a water to be treated by the water usage system 26 (a supply step), whereas the concentrates are passed through the concentrate lines 66a and 66b respectively and discharged. The permeates obtained in the second reverse osmosis membrane treatment may each be supplied as a water to be treated by separate water usage systems outside the system.

In those cases where the water to be treated in the first stage reverse osmosis membrane treatment contains organic matter such as low-molecular weight matter, there is a possibility that this organic matter such as low-molecular weight matter may permeate into the permeate from the first stage reverse osmosis membrane treatment, causing contamination of the second stage reverse osmosis membrane. By introducing a satisfactory concentration of a permeable iodine-based oxidizing agent into the water to be treated by the first stage reverse osmosis membrane, contamination of the permeate line of the first stage reverse osmosis membrane and the reverse osmosis membrane of the second stage can be suppressed.

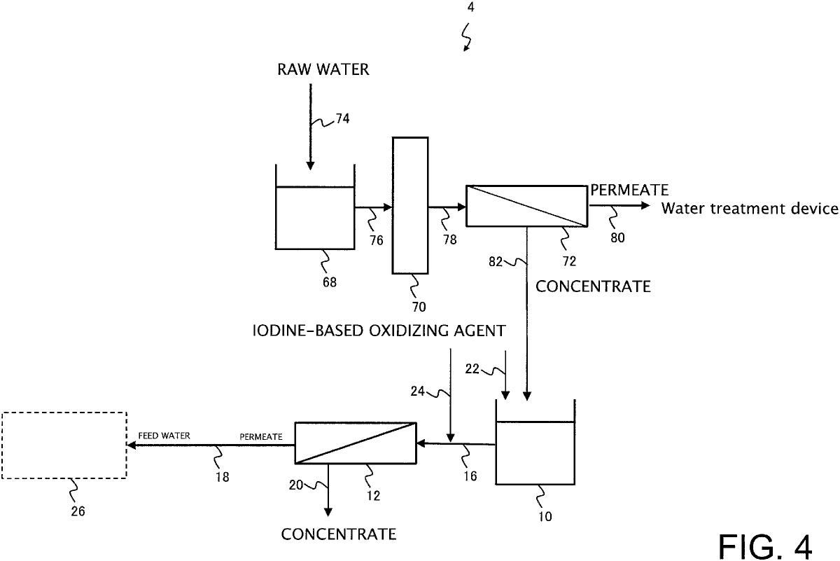

In the water recovery system and water recovery method according to embodiments of the present invention, the water to be treated may be a concentrate obtained from a reverse osmosis membrane treatment unit of a prior stage. An example of a water recovery system having this type of structure is illustrated in FIG. 4. The water recovery system 4 illustrated in FIG. 4 includes an upstream reverse osmosis membrane treatment device 72 which functions as a prior stage reverse osmosis membrane treatment unit for separating a raw water containing organic matter into a permeate and a concentrate using a reverse osmosis membrane, and the reverse osmosis membrane treatment device 12 which functions as a reverse osmosis membrane treatment unit for conducting an additional separation of the concentrate from the prior stage reverse osmosis membrane treatment unit into a permeate and a concentrate using a reverse osmosis membrane. The water recovery system 4 may also include a raw water tank 68 for storing the raw water containing organic matter, an activated carbon treatment device 70 which subjects the raw water containing organic matter to an activated carbon treatment, and the water to be treated tank 10 for storing the concentrate from the prior stage reverse osmosis membrane treatment unit that is used as the water to be treated.

In the water recovery system 4, a raw water line 74 is connected to the inlet of the raw water tank 68. The outlet of the raw water tank 68 and the inlet of the activated carbon treatment device 70 are connected by a raw water supply line 76. The outlet of the activated carbon treatment device 70 and the inlet on the primary side of the upstream reverse osmosis membrane treatment device 72 are connected by a activated carbon treated water supply line 78. A permeate line 80 is connected to the permeate outlet on the secondary side of the upstream reverse osmosis membrane treatment device 72, whereas the concentrate outlet on the primary side and the inlet of the water to be treated tank 10 are connected by a concentrate line 82. The outlet of the water to be treated tank 10 and the inlet on the primary side of the reverse osmosis membrane treatment device 12 are connected by the water to be treated supply line 16. The permeate line 18 is connected to the permeate outlet on the secondary side of the reverse osmosis membrane treatment device 12, while the concentrate line 20 is connected to the concentrate outlet on the primary side, and the permeate line 18 is connected to the water usage system 26 outside the system. The iodine-based oxidizing agent addition line 22 or the iodine-based oxidizing agent addition line 24 is connected to at least one of the water to be treated tank 10 and the water to be treated supply line 16 as an iodine-based oxidizing agent addition unit that adds an iodine-based oxidizing agent to the water to be treated.

In the water recovery system 4, the raw water containing organic matter is passed through the raw water line 74 and, if necessary, is fed into the raw water tank 68 and stored. The raw water is then fed into the activated carbon treatment device 70 through the raw water supply line 76, and an activated carbon treatment is conducted in the activated carbon treatment device 70 (an activated carbon treatment step). The activated carbon treated water that has undergone the activated carbon treatment is passed through the activated carbon treated water supply line 78 and supplied to the upstream reverse osmosis membrane treatment device 72, and is separated into a permeate and a concentrate by the reverse osmosis membrane in the upstream reverse osmosis membrane treatment device 72 (an upstream reverse osmosis membrane treatment step). The permeate obtained in this upstream reverse osmosis membrane treatment is passed through the permeate line 80 and discharged, whereas the concentrate is passed through the concentrate line 82 as a water to be treated and, if necessary, is fed into the water to be treated tank 10 and stored. In the water to be treated tank 10, an iodine-based oxidizing agent is passed through the iodine-based oxidizing agent addition line 22 and added to the water to be treated, thereby introducing an iodine-based oxidizing agent (an iodine-based oxidizing agent addition step). The iodine-based oxidizing agent may also be added to the concentrate line 82, or as illustrated in FIG. 4, may be passed through the iodine-based oxidizing agent addition line 24 and added to the water to be treated supply line 16.

The water to be treated containing the added iodine-based oxidizing agent is passed through the water to be treated supply line 16 and supplied to the reverse osmosis membrane treatment device 12, and is separated into a permeate and a concentrate by the reverse osmosis membrane in the reverse osmosis membrane treatment device 12 (a reverse osmosis membrane treatment step). The permeate obtained in the reverse osmosis membrane treatment is passed through the permeate line 18 as a treated water, and is supplied to the water usage system 26 as a water to be treated (a supply step), whereas the concentrate is passed through the concentrate line 20 and discharged.

In those cases where the raw water for the upstream reverse osmosis membrane treatment contains organic matter such as low-molecular weight organic matter, the organic matter such as low-molecular weight organic matter will, of course, be incorporated within the concentrate from the upstream reverse osmosis membrane. In those cases where the concentrate from the upstream reverse osmosis membrane treatment is subjected to an additional reverse osmosis membrane (brine RO) treatment, there is a possibility that the organic matter such as low-molecular weight organic matter incorporated in this concentrate may cause slime contamination of the water to be treated tank 10 and the permeate line 18 of the reverse osmosis membrane treatment device 12. By introducing a satisfactory concentration of a permeable iodine-based oxidizing agent into the concentrate from the upstream reverse osmosis membrane treatment device 72, namely the water to be treated by the reverse osmosis membrane treatment device 12, contamination of the water to be treated tank 10 and the permeate line 18 of the reverse osmosis membrane treatment device 12 can be suppressed.

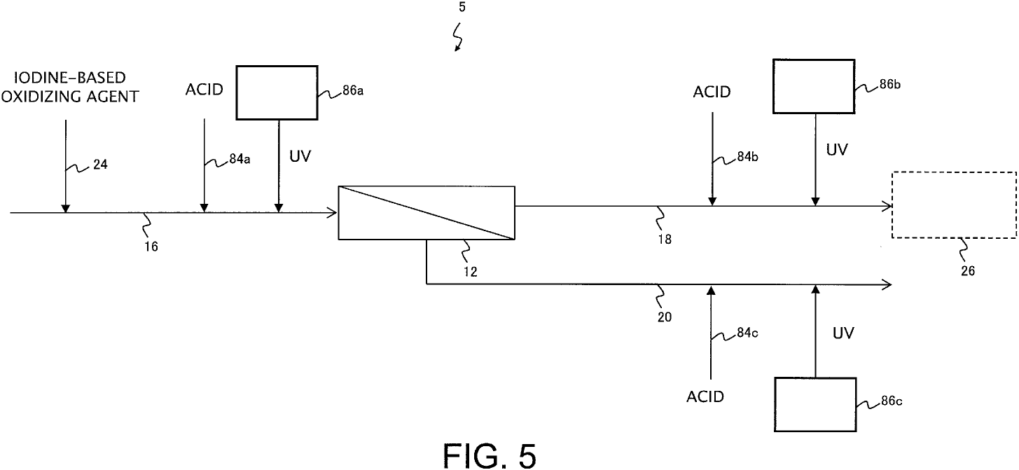

In the water recovery system and water recovery method according to embodiments of the present invention, it is preferable that either an acid is added to, or a UV irradiation is conducted on, the water to be treated containing the added iodine-based oxidizing agent, or the permeate or concentrate from the reverse osmosis membrane unit. An example of a water recovery system having this type of structure is illustrated in FIG. 5.

The water recovery system 5 illustrated in FIG. 5 also includes at least one of an acid addition line 84a, 84b or 84c that functions as an acid addition unit for performing acid addition, or a UV irradiation device 86a, 86b or 86c that functions as a UV irradiation unit for conducting UV irradiation, with respect to at least one of the water to be treated following addition of the iodine-based oxidizing agent, the permeate, and the concentrate.

In the water recovery system 5, at least one of the acid addition line 84a or the UV irradiation device 86a, the acid addition line 84b or the UV irradiation device 86b, or the acid addition line 84c or the UV irradiation device 86c is installed in at least one location among a position within the water to be treated supply line 16 that is downstream from the connection point for the iodine-based oxidizing agent addition line 24, the permeate line 18, and the concentrate line 20.

The water to be treated containing the added iodine-based oxidizing agent is subjected to either acid addition or UV irradiation (an acid addition step or UV irradiation step), and the water to be treated is then supplied to the reverse osmosis membrane treatment device 12 through the water to be treated supply line 16, and is separated into a permeate and a concentrate by the reverse osmosis membrane in the reverse osmosis membrane treatment device 12 (a reverse osmosis membrane treatment step). The permeate from the reverse osmosis membrane treatment may be subjected to either acid addition or UV irradiation (an acid addition step or UV irradiation step) and then supplied to the water usage system 26 as a water to be treated (a supply step), and the concentrate may be subjected to either acid addition or UV irradiation (an acid addition step or UV irradiation step) and then passed through the concentrate line 20 and discharged.

Despite the iodine permeating through the reverse osmosis membrane in a satisfactory concentration, the sterilizing power required for slime suppression downstream the secondary side of the reverse osmosis membrane may sometimes become inadequate as a result of a reduction in sterilizing power arising from consumption of the iodine during the sterilization of microbes. In the water recovery system 5 of FIG. 5, by conducting either acid addition or UV irradiation on the water to be treated following addition of the iodine-based oxidizing agent, or the permeate or the concentrate from the reverse osmosis membrane, the iodine consumed by sterilization can be reactivated, ensuring that satisfactory sterilizing power can be achieved downstream from the secondary side.

The acid added to the concentrate may be any acidic substance, but the use of an acidic solution is preferred, and the use of a strong acid such as hydrochloric acid, sulfuric acid or nitric acid is more preferred.

There are no particular limitations on the UV irradiation device, provided it is capable of irradiating ultraviolet rays (for example, light of 100 nm to 400 nm, and preferably light that includes light of 254 nm).

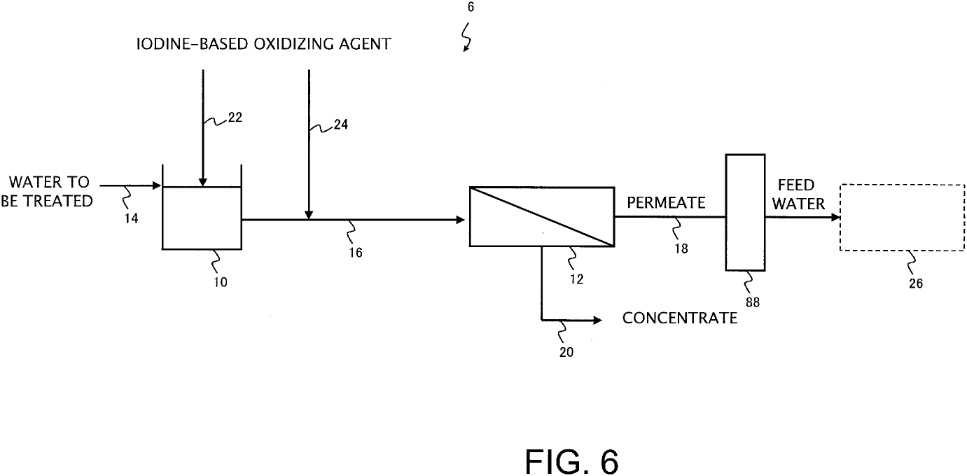

In the water recovery system and water recovery method according to embodiments of the present invention, an iodine removal unit may be used on the permeate from the reverse osmosis membrane obtained by using the reverse osmosis membrane treatment unit. An example of a water recovery system having this type of structure is illustrated in FIG. 6.

The water recovery system 6 illustrated in FIG. 6 includes an iodine removal device 88 as an iodine removal unit for removing iodine components from within the permeate. Alternatively, the water usage system 26 may include an iodine removal device as an iodine removal unit for removing iodine components from within the permeate.

In the water recovery system 6, the iodine removal device 88 is installed in the permeate line 18, and the permeate obtained in the reverse osmosis membrane treatment is subjected to removal of iodine components from within the permeate in the iodine removal device 88 (an iodine removal step), and is then supplied to the water usage system 26 as a water to be treated (a supply step). Alternatively, an iodine removal device is installed within the water usage system 26, the permeate obtained in the reverse osmosis membrane treatment is supplied to the water usage system 26 as a water to be treated (a supply step), and iodine components may then be removed from within the permeate in the iodine removal device in the water usage system 26 (an iodine removal step).

In the water usage system 26 that is supplied with the permeate from the reverse osmosis membrane treatment device 12, by installing an iodine removal device either within the water usage system 26 or upstream from the water usage system 26, objectives such as meeting iodine control standards and reducing the iodine load on the water usage system 26 can be achieved.

One or more of reducing agent addition, activated carbon, an anion exchanger, a scrubber and a degassing membrane may be used as the iodine removal unit, and the use of activated carbon or an anion exchanger is preferred. Either an activated carbon filtration device or an activated carbon filter may be used as the activated carbon, and an activated carbon filter is preferred. Either a weak anion exchange resin or a strong anion exchange resin may be used as the anion exchanger, and a strong anion exchange resin is preferred. The iodine removal unit may be installed in a location prior to supply of the permeate from the reverse osmosis membrane treatment device 12 to the water usage system 26 or may be installed within the water usage system 26, or a combination of both locations may be used.

### Iodine-Based Slime Inhibitor

The iodine-based slime inhibitor according to an embodiment of the present invention is a slime inhibitor used for suppressing slime on the secondary side of the reverse osmosis membrane in the water recovery system and water recovery method described above, and is capable of suppressing slime contamination even on the secondary side of the reverse osmosis membrane during water recovery from a water to be treated containing organic matter using a reverse osmosis membrane.

### EXAMPLES

The present invention is described below more specifically and in further detail using a series of examples and comparative examples, but the present invention is in no way limited by the following examples.

### Testing Effects on Reverse Osmosis Membrane Permeation Rates and Rejection Rates

### <Example 1>

Under the test conditions described below, an iodine-based oxidizing agent (1) prepared using the method described below was added to a series of reverse osmosis membrane device feed waters (water to be treated), and the total chlorine permeation rate for the reverse osmosis membrane, the permeate flux retention rate, the reverse osmosis membrane rejection rate, the increase in differential pressure, and the bacterial count in the concentrate were compared. The total chlorine permeation rate for the reverse osmosis membrane was determined by measuring the total chlorine concentration in the water to be treated and the total chlorine concentration in the permeate, the permeate flux was determined as [(permeate volume) / (membrane surface area supply pressure) x water temperature correction coefficient], the permeate flux retention rate was determined as [(actual measured permeate flux) / (initial permeate flux) x 100], the reverse osmosis membrane rejection rate was determined as [(1 - (permeate EC / feed water EC)) x 100], the water flow differential pressure was determined as [feed water pressure - concentrate pressure] using a differential pressure meter, and the bacterial count was measured using a Sheet Check R2A (manufactured by Nipro Corporation). The organic matter content was measured using a Sievers 900 TOC analyzer manufactured by GE Analytical Instruments Inc.

### (Test Conditions)

Test water: Sagamihara well water (dechlorinated, adjusted to a pH within a range from 7.0 to 4.0 using hydrochloric acid, organic matter content: 0.15 mg/L, bacterial count: 2×10³ CFU/mL)
pH: 7.5, 7.0, 6.5, 6.0, 5.5, 5.0, 4.5, 4.0
Reverse osmosis membrane: a four-inch reverse osmosis membrane element (LFC3), manufactured by Nitto Denko Corporation
Reagent: Iodine-based oxidizing agent (1)

### (Iodine-Based Oxidizing Agent (1))

This reagent was prepared by mixing iodine, a 48% aqueous solution of potassium hydroxide and water in the formulation (% by mass) shown in Table 3. The pH, total chlorine concentration (% by mass) and organic matter content (TOC) (mg/L) of the composition were as shown in Table 3. The total chlorine concentration was measured using a multi-item water quality analyzer DR/3900 manufactured by Hach Company. The organic matter content (TOC) was measured using a Sievers 900 TOC analyzer manufactured by GE Analytical Instruments Inc. A more detailed description of the method for preparing the iodine-based oxidizing agent (1) is presented below.

Specifically, the 48% aqueous solution of potassium hydroxide was dissolved in the water under stirring to form a substantially uniform solution, and the iodine was then added and stirred for about 30 minutes to complete preparation of a substantially uniform iodine-based oxidizing agent.

TABLE 3

| | | Iodine-based oxidizing agent | | | | | | | |
|---|---|---|---|---|---|---|---|---|---|
| | | (1) | (2) | (3) | (4) | (5) | (6) | (7) | (8) |
| Formulation [% by mass] | Water | 72.8 | 63.9 | 64.8 | 64.3 | 89.84 | 60 | 69.8 | 66.8 |
| | Iodine | 18.4 | 16.1 | 152 | 17.5 | 0.16 | 20 | 102 | 22.8 |
| | KI | - | 20 | 20 | - | - | 20 | 20 | - |
| | 48% KOH | 8.8 | - | - | 8.9 | - | - | - | 10.3 |
| | Potassium sulfamate | - | - | - | 9.3 | - | - | - | - |
| | Polyvinylpyrrolidone (Mw: 8,000) | - | - | - | - | 10 | - | - | - |
| Physical properties | pH | 9.35 | 6.25 | 5.66 | 8.6 | 2.4 | 5.57 | 6.06 | 9.08 |
| | Total iodine [% by mass] | 2.4 | 4.5 | 4.2 | 2.2 | 0.04 | 5.2 | 2.9 | 3.1 |
| | TOC [mg/L] | <10 | <10 | <10 | - | - | <10 | <10 | <10 |

The pH measurements were performed under the following conditions.
Electrode type: glass electrode
pH meter: HM-42X model, manufactured by DKK-TOA Corporation
Electrode calibration: three-point calibration was performed using the pH (4.01) of a phthalate standard solution (type 2) manufactured by Kanto Chemical Co., Inc., and the pH (6.86) of a neutral phosphate standard solution (type 2) and the pH (9.18) of a borate standard solution (type 2) manufactured by the same company.

Measurement temperature: 25° C.

Measured value: the electrode was immersed in the liquid undergoing measurement, the value following stabilization was recorded as the measured value, and the average of three measurements was recorded.

The iodine-based oxidizing agent (1) was added to the reverse osmosis membrane feed water that had been adjusted to a pH within a range from 7.0 to 4.0 in an amount sufficient to yield a total chlorine concentration in the concentrate of 0.05 mg/L (Examples 1-1 to 1-8). The results are shown in Table 4.

TABLE 4

| | pH | Total chlorine permeation rate [%] | Flux retention rate [%] | EC rejection rate [%] | Differential pressure increase [%] | Concentrate bacterial count [CFU/mL] |
|---|---|---|---|---|---|---|
| Example 1-1 | 7.5 | 90 | 100 | 99 | 0 | <10 |
| Example 1-2 | 7.0 | 90 | 100 | 99 | 0 | <10 |
| Example 1-3 | 6.5 | 90 | 100 | 99 | 0 | <10 |
| Example 1-4 | 6.0 | 90 | 100 | 98 | 0 | <10 |
| Example 1-5 | 5.5 | 90 | 100 | 98 | 0 | <10 |
| Example 1-6 | 5.0 | 90 | 100 | 97 | 0 | <10 |
| Example 1-7 | 4.5 | 90 | 100 | 97 | 0 | <10 |
| Example 1-8 | 4.0 | 90 | 100 | 97 | 0 | <10 |

The total chlorine permeation rate was 90% under all of the pH conditions, almost no reduction in the permeate volume was observed, and there was almost no increase in the differential pressure. There was almost no effect on the reverse osmosis membrane rejection rate (excluding a reduction in rejection rate caused by weakened reverse osmosis membrane charge repulsion due to the decrease in pH), and the bacterial count in the concentrate was reduced to a similar level. These results indicated that the iodine-based oxidizing agent (1) exhibited a permeation rate through the reverse osmosis membrane of 90%, had almost no effect on the reverse osmosis membrane, and was able to produce a satisfactory sterilizing power.

### <Example 2, Comparative Example 1>

### Investigations of Total Iodine CT Value

Water treatments were conducted with different value for the total iodine CT value (mg/L·h), represented by (total iodine within the water to be treated (mg/L)) x (iodine-based oxidizing agent addition time (h)). The results are shown in Table 5.

### (Test Conditions)

Test water: Sagamihara well water (dechlorinated, bacterial count: 2×10³ CFU/mL)
Reagent: an iodine-based oxidizing agent (2) prepared with the formulation (% by mass) shown in Table 3 using the same method as that described for the iodine-based oxidizing agent (1) was used
pH: 7.0
Reverse osmosis membranes: ES20, ESPA2, LFC3, TML10D

TABLE 5

| | Total iodine CT value (mg/L·h) | Total iodine concentration C in water to be treated (mg/L) | Addition time T (h) | Total iodine concentration in permeate (mg/L) |
|---|---|---|---|---|
| Comparative Example 1-1 | 0.43 | 5.4 | 0.08 | 0.03 |
| Comparative Example 1-2 | 0.46 | 2.7 | 0.17 | |
| Comparative Example 1-3 | 0.45 | 0.9 | 0.5 | |
| Comparative Example 14 | 0.50 | 0.25 | 2 | |
| Example 2-1 | 0.68 | 2.7 | 0.25 | 0.1 |
| Example 2-2 | 0.70 | 5.4 | 0.13 | |
| Example 2-3 | 0.75 | 0.9 | 0.83 | |
| Example 2-4 | 0.75 | 0.25 | 3 | |
| Example 2-5 | 0.90 | 5.3 | 0.17 | 0.14 |
| Example 2-6 | 0.89 | 2.7 | 0.33 | |
| Example 2-7 | 0.90 | 0.9 | 1 | |
| Example 2-8 | 1.0 | 0.25 | 4 | |
| Example 2-9 | 1.1 | 0.9 | 1.2 | 0.18 |
| Example 2-10 | 1.1 | 2.7 | 0.42 | |
| Example 2-11 | 12 | 5.4 | 0.22 | |
| Example 2-12 | 125 | 0.25 | 5 | |

Regardless of the total iodine concentration in the water to be treated, the bacterial count in the permeate was reduced to <10. It was evident that in order to increase the total iodine concentration in the permeate, the total iodine CT value was preferably at least 0.7.

[Differences in Reverse Osmosis Membrane Permeation Rate for Different Reagents]

### <Examples 3 to 6>

Using the method described below, testing was conducted to confirm the differences in the reverse osmosis membrane permeation rates for different reagents.

### (Test Conditions)

Test water: Sagamihara well water (dechlorinated, organic matter content: 0.15 mg/L)
pH: adjusted to 7.0
   Reverse osmosis membrane: a four-inch reverse osmosis membrane element (LFC3), manufactured by Nitto Denko Corporation
Reagents: the iodine-based oxidizing agent (1) was used in Example 3, an iodine-based oxidizing agent (3), an iodine-based oxidizing agent (4) and an iodine-based oxidizing agent (5), each prepared with a formulation (% by mass) shown in Table 3 using the same method as that described for the iodine-based oxidizing agent (1), were used in Examples 4, 5 and 6 respectively.

Each of the above reagents was added continuously to the water to be treated for a period of at least 12 hours, the total chlorine concentration in the water to be treated and the total chlorine concentration in the permeate were measured, and the permeation rate was determined. The results are shown in Table 7.

When measurements were conducted in Examples 3 to 6 using each of the iodine-based oxidizing agents (1) and (3) to (5), the permeation rate was about 90% in Examples 3 and 4, about 83% in Example 5, and about 78% in Example 6. It was evident that the formulations prepared using iodine and either potassium hydroxide or potassium iodide permeated readily through the reverse osmosis membrane, providing a satisfactory slime inhibitory effect on the permeate from the reverse osmosis membrane.

### <Example 7>

Using the method described below, testing was conducted to confirm the degree of iodine permeation.

### (Test Conditions)

Test water: Sagamihara well water (dechlorinated)
Test device: reverse osmosis membrane element test device
Reagents: the iodine-based oxidizing agents (6), (3) and (7) prepared with the formulations shown in Table 3 by mixing iodine and potassium iodide so as to achieve a molar ratio of iodide relative to iodine (iodide/iodine) of 1.5, 2 and 3 respectively were used.

### (Measurement of Total Iodine Atoms)

The total amount of iodine atoms was measured by ICP-MS (ELAN DRC-e ICP Mass Spectrometer, manufactured by PerkinElmer, Inc.). An adequate amount of sodium thiosulfate was added to the sample water to reduce all of the iodine, ammonia water was used to adjust the pH to a value of 9 to 10 to stabilize the ions, and measurement was then performed. A calibration curve was created using potassium iodide.

The total iodine atom concentration of a sample of the water to be treated by the reverse osmosis membrane was measured, and the measured value was multiplied by the addition time to calculate the total iodine CT value.

$$\begin{matrix}\text{Total iodine CT value} \left(\text{mg} / \text{L} ⋅ \text{min}\right) = \\ \left(\text{total iodine atom}\right) \text{concentration in water to be treated} \\ \left(\text{mg} / \text{L}\right) \times \left(\text{additional time} \left(min\right)\right)\end{matrix}$$

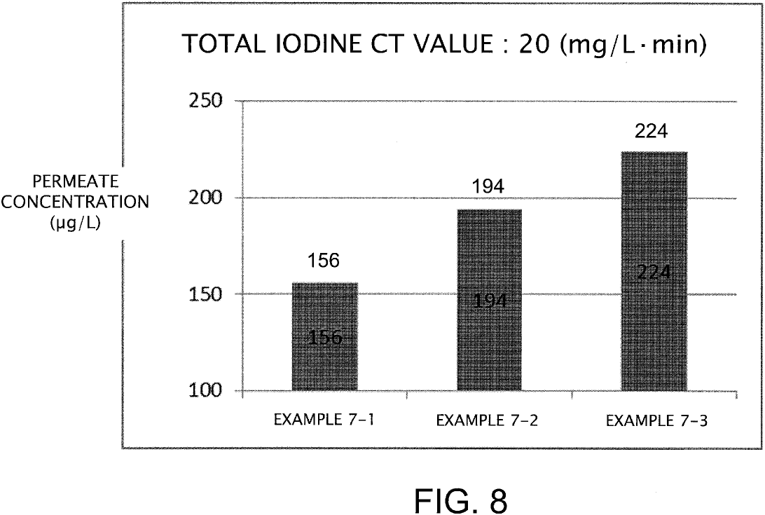

In Example 7-1, Example 7-2 and Example 7-3, when the iodine-based oxidizing agents (6), (3) and (7) respectively were added continuously so as to achieve a total iodine CT value of 20 (mg/L·min), the amounts of iodine permeation observed were 156 µg/L, 194 µg/L and 224 µg/L respectively. The results are shown in FIG. 8.

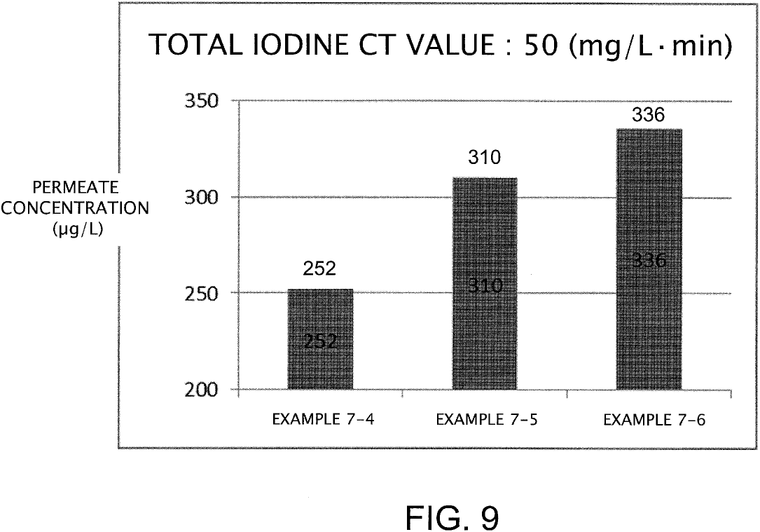

In Example 7-4, Example 7-5 and Example 7-6, when the iodine-based oxidizing agents (6), (3) and (7) respectively were added continuously so as to achieve a total iodine CT value of 50 (mg/L·min), the amounts of iodine permeation observed were 252 µg/L, 310 µg/L and 336 µg/L respectively. The results are shown in FIG. 9.

Regardless of whether the total iodine CT value was 20 (mg/L·min) or 50 (mg/L·min), it was evident that the iodine concentration in the permeate increased as the molar ratio of iodide relative to iodine increased. It is clear that increasing the molar ratio of iodide relative to iodine is effective in promoting iodine permeation.

### Differences in Permeation Rate for Different Membrane Types

### <Example 8>

Using the method described below, testing was conducted to confirm the differences in permeation rates for different membrane types.

### (Test Conditions)

Test water: Sagamihara well water (dechlorinated, organic matter content: 0.15 mg/L)
pH: adjusted to 7.0
Reverse osmosis membrane: a four-inch reverse osmosis membrane element LFC3 (manufactured by Nitto Denko Corporation) was used in Example 8-1, a four-inch reverse osmosis membrane element ES20 (manufactured by Nitto Denko Corporation) was used in Example 8-2, and a four-inch reverse osmosis membrane element CPA5 (manufactured by Nitto Denko Corporation) was used in Example 8-3
Reagent: the iodine-based oxidizing agent (1)

In Example 8-1, Example 8-2 and Example 8-3, the membrane elements LFC3, ES20 and CPA5 having reverse osmosis membrane surface chlorine content values of 0.5 atom%, 1.1 atom% and 0 atom% respectively were used, and in each case the total chlorine concentration of the water to be treated and the total chlorine concentration of the permeate were measured, and the permeation rate was determined. The results are shown in Table 6. The chlorine content of the reverse osmosis membrane surfaces was measured using a Quantera SXM XPS (X-ray photoelectron Spectroscopy) analysis device manufactured by PHI, Inc.

TABLE 6

| | Membrane Model Number | Chlorine content [atom%] | Total chlorine permeation rate [%] |
|---|---|---|---|
| Example 8-1 | LFC3 | 0.5 | 90 |
| Example 8-2 | ES20 | 1.1 | 90 |
| Example 8-3 | CPA5 | 0 | 75 |

The permeation rates in Example 8-1, Example 8-2 and Example 8-3 were 90%, 90% and 75% respectively, indicating that high permeation rates were obtained. It was discovered that by ensuring that the chlorine content of the membrane surface is at least 0.1 atom%, a permeation rate of 90% can be achieved.

### Investigation of Slime Detachment Effect

### <Example 9>

Using the method described below, testing was conducted to confirm a slime detachment effect.

### (Test Conditions)

Test Water: Sagamihara well water (dechlorinated, containing 1 ppm of added acetic acid, organic matter content: 0.55 mg/L)
pH: 7.0±1
Reverse osmosis membrane: a four-inch reverse osmosis membrane element (ESPA2) manufactured by Nitto Denko Corporation
Reagent: an iodine-based oxidizing agent (8) prepared with the formulation (% by mass) shown in Table 3 using the same method as that described for the iodine-based oxidizing agent (1) was used

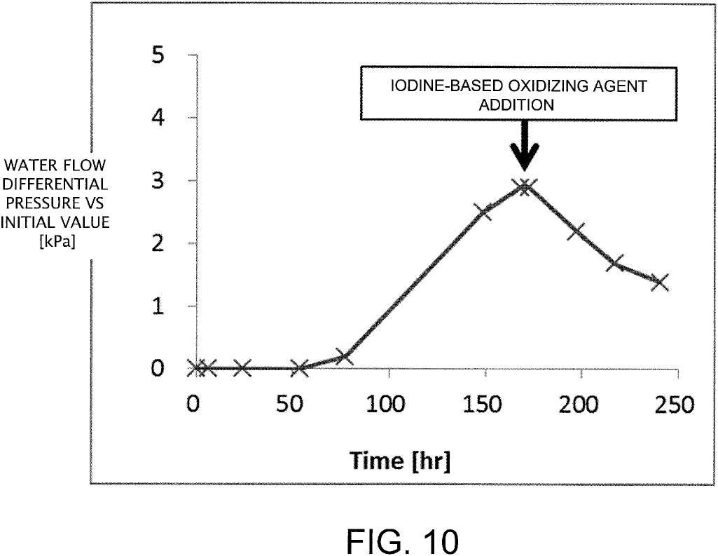

One ppm of acetic acid was added to the reverse osmosis membrane feed water (the Sagamihara well water) to promote the formation of biofilm. In Example 9, a constant 1 ppm of acetic acid was added continuously to the feed water throughout the entire test period, and after about 170 hours, the iodine-based oxidizing agent (8) was added in sufficient amount to produce a total chlorine concentration in the concentrate of 0.05 mg/L, with addition of the iodine-based oxidizing agent continued from that point onward. The results are shown in FIG. 10. In FIG. 10, the horizontal axis indicates the time (hr) from the start of operations, and the vertical axis indicates the change over time in the value obtained by subtracting the initial water flow differential pressure (kPa) from the actually measured water flow differential pressure (kPa).

As illustrated in FIG. 10, at about 80 hours after the start of operations, the differential pressure started to increase due to the formation of biofilm, and the differential pressure increased markedly thereafter, but from the point where addition of the iodine-based oxidizing agent (8) was started at about 170 hours, a gradual decrease in the differential pressure was confirmed, and it was clear that a slime detachment effect had been achieved by adding the iodine-based oxidizing agent.

### <Example 10>

Testing was conducted to ascertain whether very low concentrations of permeated organic matter could be sterilized by permeating iodine-based oxidizing agent.

### (Test Conditions)

Test Water: Sagamihara well water (dechlorinated) containing 0.01 ppm of added acetic acid (TOC of 0.004 mg/L) that had been cultured at 30° C. for three days
Reagent: an iodine-based oxidizing agent (2) prepared with the formulation (% by mass) shown in Table 3 using the same method as that described for the iodine-based oxidizing agent (1) was used
Added concentration: the reagent (2) was added in sufficient amount to obtain total chlorine of 0.05 mg/L in Example 10-1, and total chlorine of 0.10 mg/L in Example 10-2

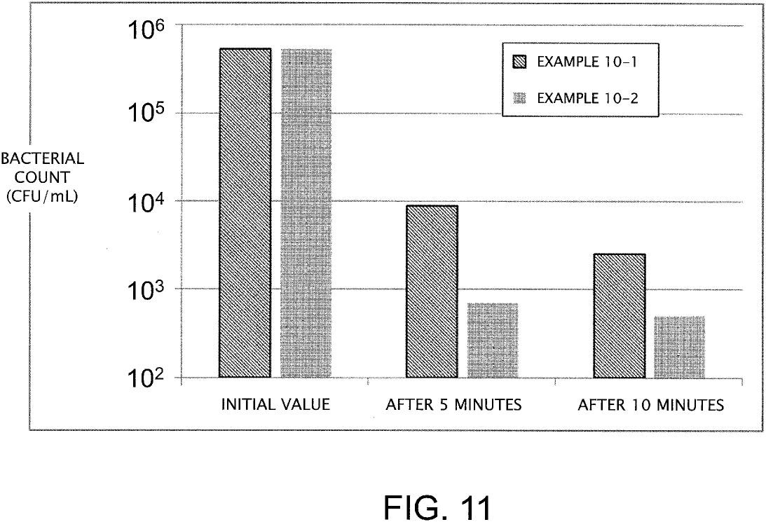

The bacterial count was measured 5 minutes after, and then 10 minutes after, the start of addition of the reagent. The bacterial count was measured using a Sheet Check R2A (manufactured by Nipro Corporation). The results are shown in FIG. 11.

Even at the low concentration levels (considered as concentration levels in the permeate) of 0.05 mg/L and 0.10 mg/L, a satisfactory sterilization effect was observed.

### Confirmation of Effects of Acid Addition and Ultraviolet Irradiation

### <Example 11>

Using the method described below, testing was conducted to confirm the effects of acid addition.

### (Test Conditions)

Test Water: the iodine-based oxidizing agent (8) was diluted with pure water to achieve a total chlorine concentration of 0.05 mg/L. The pH was 5.69.
Acid reagent: hydrochloric acid was used as a pH modifier

The hydrochloric acid was added to the test water having an initial pH of 5.69 and a total chlorine concentration of 0.05 mg/L to adjust the pH to 3.08 in Example 11-1, and to adjust the pH to 1.91 in Example 11-2. The results are shown in Table 7.

TABLE 7

| | pH | Total chlorine concentration [mg/L] | Total iodine concentration [mg/L] |
|---|---|---|---|
| Initial values | 5.69 | 0.05 | 0.18 |
| Example 11-1 | 3.08 | 0.07 | 0.25 |
| Example 11-2 | 1.91 | 0.09 | 0.32 |

When the pH was set to 3.08 in Example 11-1, and set to 1.91 in Example 11-2, the total chlorine concentration increased to 0.07 mg/L and 0.09 mg/L respectively, confirming an increase in the active component.

### <Example 12>

Using the method described below, testing was conducted to confirm the effects of ultraviolet irradiation.

### (Test Conditions)

Test Water: the iodine-based oxidizing agent (8) was diluted with pure water to achieve a total chlorine concentration of 0.43 mg/L.
Ultraviolet radiation: 254 nm

The test water having a total chlorine concentration of 0.43 mg/L was irradiated with ultraviolet radiation of 254 (nm) for 30 seconds. The results are shown in Table 8.

TABLE 8

| | Total chlorine concentration prior to irradiation [mg/L] | Total chlorine concentration Following irradiation [mg/L] |
|---|---|---|
| Example 12 | 0.43 | 0.50 |

When the test water was irradiated with ultraviolet radiation of 254 (nm), the total chlorine following irradiation increased to 0.50 mg/L, confirming an increase in the active component.

### Reverse Osmosis Membrane Adsorption Test

### <Example 13>

Using the method described below, testing was conducted to confirm adsorption to the reverse osmosis membrane.

### (Test Conditions)

Test device: reverse osmosis membrane element test device
Operating pressure: 0.75 MPa
Feed water: Sagamihara well water (dechlorinated, adjusted to a pH of 7.0 using hydrochloric acid, organic matter content: 0.15 mg/L, bacterial count: 2×10³ CFU/mL)
Reagent: the iodine-based oxidizing agent (1)
Reverse osmosis membrane: a four-inch reverse osmosis membrane element (LFC3), manufactured by Nitto Denko Corporation

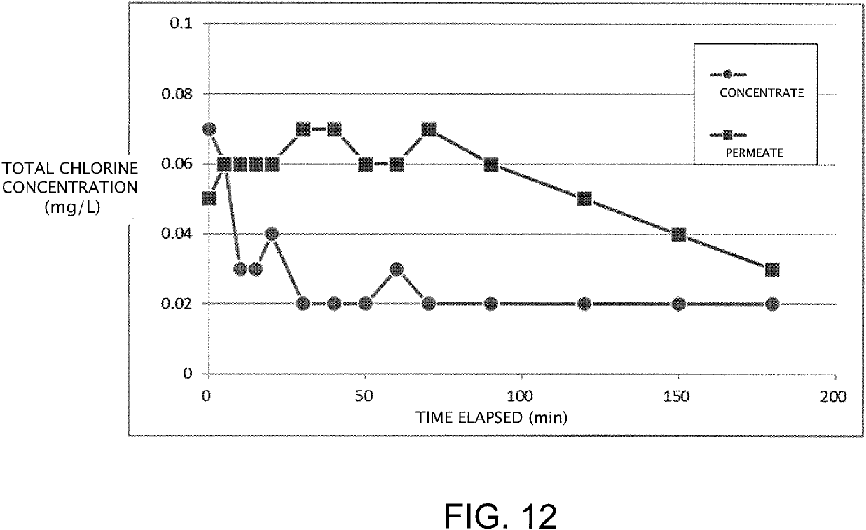

The iodine-based oxidizing agent (1) was added continuously to the water to be treated for at least 24 hours, and then reagent addition was stopped, and the change over time in the active component concentration in the concentrate and the permeate was confirmed. FIG. 12 illustrates the total chlorine concentration (mg/L) relative to the time elapsed (min).

As illustrated in FIG. 12, it is thought that the continued detection of the active component in the concentrate and the permeate even after stopping reagent addition indicates that adsorbed active component is gradually released.

As described above, in water recovery of a water to be treated containing organic matter using a reverse osmosis membrane, adding an iodine-based oxidizing agent to the water to be treated by the reverse osmosis membrane, as described in the examples, is able to suppress slime contamination even on the secondary side of the reverse osmosis membrane.

### REFERENCE SIGNS LIST

1, 2, 3, 4, 5, 6: Water recovery system
2: Water treatment system
10: Water to be treated tank
12, 12a, 12b, 12c, 12d: Reverse osmosis membrane treatment device
14: Water to be treated line
16, 16a, 16b, 16c, 16d: Water to be treated supply line
18, 18a, 18b, 18c, 18d, 32, 62a, 62b, 64a, 64b, 80: Permeate line
20, 20a, 20b, 20c, 20d, 34, 66a, 66b, 82: Concentrate line
22, 24, 24a, 24b, 24c, 24d, 54a, 54b, 54c: Iodine-based oxidizing agent addition line
26: Water usage system
30: Second reverse osmosis membrane treatment device
36: Biological treatment device
38: Biologically treated water tank
40: Membrane treatment device
42: Membrane treated water tank
44, 74: Raw water line
46: Biologically treated water line
48: Biologically treated water supply line
50: Membrane treated water line
56: Biological treatment system
60a, 60b: Second reverse osmosis membrane treatment device
68: Raw water tank
70: Activated carbon treatment device
72: Upstream reverse osmosis membrane treatment device
76: Raw water supply line
78: Activated carbon treated water supply line
84a, 84b, 84c: Acid addition line
86a, 86b, 86c: UV irradiation device
88: Iodine removal device

1. A water recovery system comprising:
a reverse osmosis membrane which separates a water to be treated containing organic matter into a permeate and a concentrate using the reverse osmosis membrane,
an iodine-based oxidizing agent addition line which adds an iodine-based oxidizing agent to the water to be treated, and
a supply line which supplies the permeate as a water to be treated in a water usage system.

2. The water recovery system according to claim 1, wherein the water to be treated contains organic matter with a molecular weight of 500 or lower.

3. The water recovery system according to claim 1, wherein an organic matter concentration in the permeate, expressed as TOC, is at least 0.01 mg/L.

4. The water recovery system according to claim 1, wherein
a total chlorine concentration in the permeate is at least 0.01 mg/L.

5. The water recovery system according to claim 1, wherein
the reverse osmosis membrane is a polyamide-based reverse osmosis membrane, and
a chlorine content of a membrane surface of the reverse osmosis membrane is at least 0.1 atom%.

6. The water recovery system according to claim 1, wherein
the water recovery system further comprises an iodine removal device which removes iodine components from within the permeate, or
the water usage system comprises an iodine removal device which removes iodine components from within the permeate.

7. An iodine-based slime inhibitor which can be used in the water recovery system according to claim 1.

8. The iodine-based slime inhibitor according to claim 7,
which contains water, iodine and an iodide, and has an organic matter content of less than 100 mg/L.

9. A water recovery method comprising:
separating a water to be treated containing organic matter into a permeate and a concentrate using a reverse osmosis membrane,
adding an iodine-based oxidizing agent to the water to be treated, and
supplying the permeate as a water to be treated in a water usage system.
